(19) United States
(12) Patent Application Publication
(10) Pub. No.: US 2001/0002140 A1
(43) Pub. Date: May 31, 2001

(54) High speed scanning

(75) Inventors: Moshe Medan, Ramat Hasharon (IL); Chezy Baer, Dolev (IL); Izchak Zubalsky, Herzlia (IL)

Correspondence Address: DARBY & DARBY P.C., 805 Third Avenue, New York, NY, 10022, US

(73) Assignee: TAMAM INDUSTRIES

(21) Appl. No.: 09/755,326

(22) Filed: Jan. 5, 2001

Related U.S. Application Data
(63) Continuation of application No. 08/811,049, filed on Mar. 4, 1997, now abandoned.

(30) Foreign Application Priority Data
Mar. 6, 1996 (IL) 117391

(51) Int. Cl. H04N 7/00

(52) U.S. Cl. 348/38; 348/36

(57) ABSTRACT

This invention discloses an imaging system including at least one focal plane array, a plurality of optical pathways, each viewing different scenes, and an optical switching assembly operative to supply to the at least one focal plane array outputs of the plurality of optical pathways in a time-shared manner.

### FIELD OF THE INVENTION

The present invention relates to imaging apparatus generally and more particularly to imaging apparatus employing fixed focal plane arrays.

### BACKGROUND OF THE INVENTION

Various types of imaging systems employing fixed focal plane arrays are known in the patent literature. The following U.S. patents are believed to represent the state of the art: U.S. Pat. Nos. 4,982,092; 4,058,831; 4,024,573; 3,959,582; 2,272,842.

### SUMMARY OF THE INVENTION

The present invention seeks to provide improved imaging apparatus employing a focal plane array.

There is thus provided in accordance with a preferred embodiment of the present invention an imaging system comprising at least one focal plane array, a plurality of optical pathways, each viewing different scenes, an optical switching assembly operative to supply to the at least one focal plane array outputs of the plurality of optical pathways in a time-shared manner.

Preferably, each focal plane array receives an output of only one of said plurality of optical pathways at a given time.

Alternatively, each focal plane array may receive multiple outputs at a given time, which outputs are refreshed at video rates. The resulting focal plane array output is operated upon by algorithms which sort out the various images.

In accordance with a preferred embodiment of the present invention, the plurality of optical pathways provide imaging over a 360 degree azimuth.

Preferably, the focal plane array is stationary relative to an inertial platform during imaging.

In accordance with a preferred embodiment of the present invention, the focal plane array operates at video rates and the optical switching assembly operates to supply a refreshed output from each of the plurality of optical pathways to the focal plane array at video rates.

In accordance with one embodiment of the present invention, the optical switching assembly employs mutually synchronized choppers associated with each of the optical pathways so as to ensure that at any given time, the focal plane array sees only one scene.

Alternatively or additionally, the optical switching assembly employs low inertia mirrors which are moved at high frequency so as to direct light from various scenes onto the focal plane array.

### BRIEF DESCRIPTION OF THE DRAWINGS

The present invention will be understood and appreciated more fully from the following detailed description, taken in conjunction with the drawings in which:

FIG. 1 is a simplified illustration of an imaging system constructed and operative in accordance with a preferred embodiment of the present invention;

FIG. 2 is a simplified illustration of an output of the imaging system of FIG. 1; and

FIG. 3 is a simplified illustration of alternative embodiment of an imaging system constructed and operative in accordance with a preferred embodiment of the present invention.

### DETAILED DESCRIPTION OF A PREFERRED EMBODIMENT

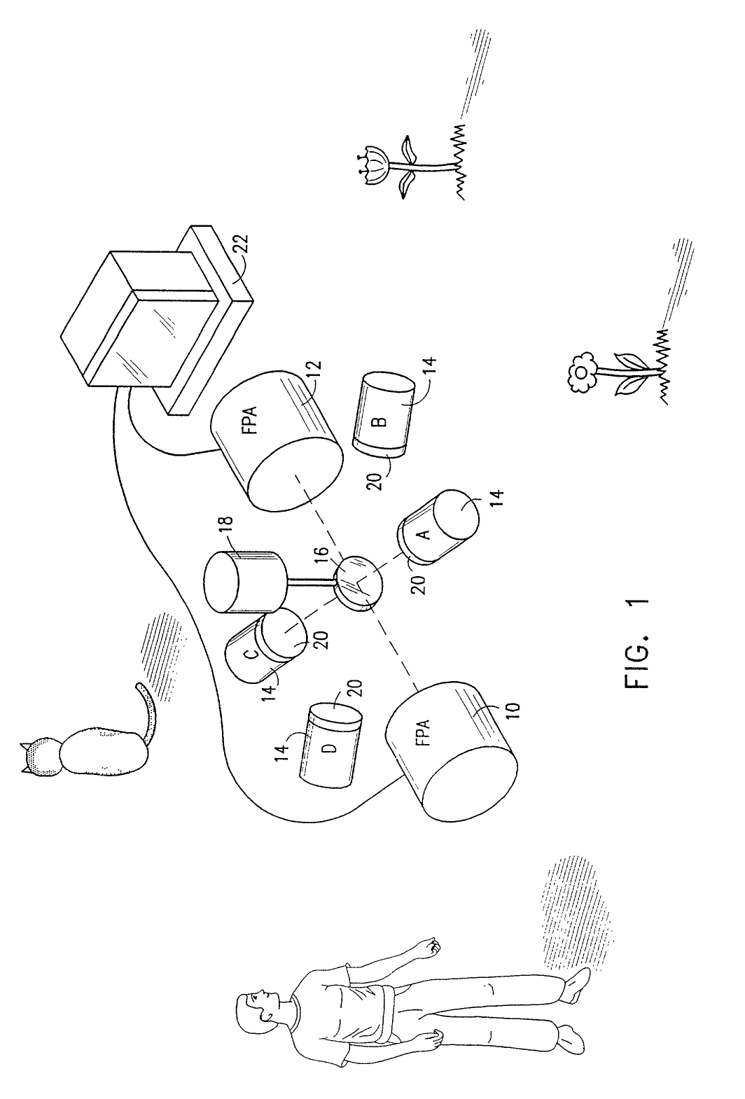

Reference is now made to FIG. 1, which is a simplified illustration of an imaging system constructed and operative in accordance with a preferred embodiment of the present invention. The imaging system of FIG. 1 typically comprises a pair of focal plane arrays 10 and 12, which may comprise CCD arrays or any other suitable detectors operative at any suitable optical wavelength. Preferably, the focal plane arrays 10 and 12 are fixed to an inertial platform.

A plurality of fixed optical pathways 14, here individually identified by the letters A, B, C and D, each image a different scene. Depending on the fields of view of the optical pathways, they may collectively image over a 360 degree azimuth. The optical pathways 14 are preferably also fixed to the same inertial platform as are the focal plane arrays 14.

A rotating, low inertia mirror 16, preferably rotatably driven by a high speed electric motor 18, images the outputs of optical pathways A and D onto focal plane array 10 and the outputs of optical pathways B and C onto focal plane array 12. Preferably, each of the optical pathways 14 is supplied with a shutter or chopper 20. The operation of each shutter or chopper 20 is preferably synchronized with the shutter or chopper 20 on another optical pathway 14 which is also imaged onto the same focal plane array so as to ensure that the respective outputs of the optical pathways 14 are supplied to the focal plane array in mutual time sharing relationship.

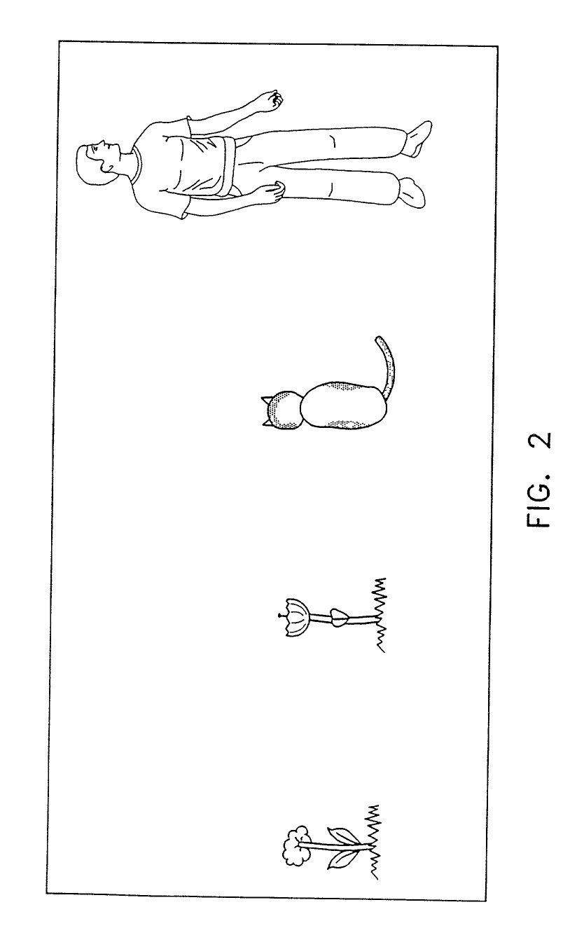

The outputs of the focal plane arrays 10 and 12 may be supplied to a display 22, producing a combined display image, seen in FIG. 2, which includes all of the scenes which are imaged by the optical pathways 14. It is a particular feature of the present invention that the scenes are each refreshed at full video rates.

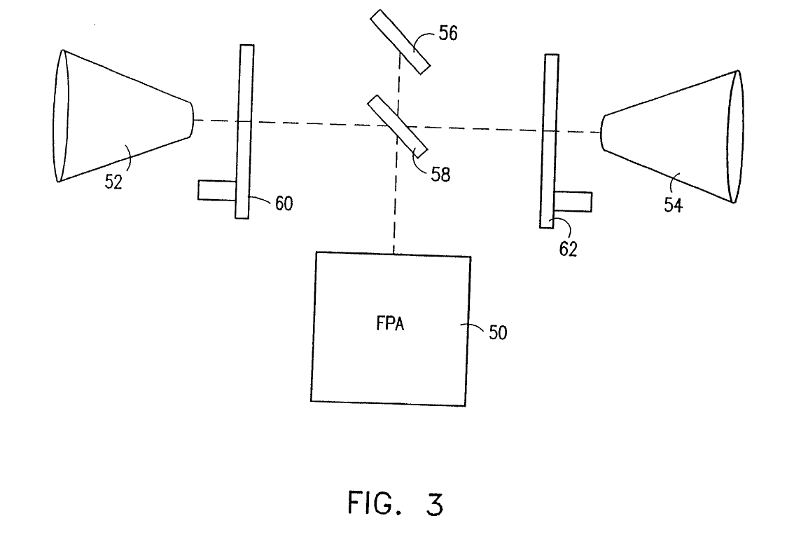

Reference is now made to FIG. 3, which is a simplified illustration of an alternative embodiment of an imaging system constructed and operative in accordance with a preferred embodiment of the present invention. In this embodiment, a single focal plane array 50 receives optical inputs from first and second optical pathways 52 and 54 via a mirror 56 and beam splitter 58. Associated with each of the first and second optical pathways 52 and 54 are respective choppers 60 and 62. It is appreciated that for infra-red applications, the focal plane array, the optical paths and the choppers may be cooled.

It will be appreciated by persons skilled in the art that the present invention is not limited by what has been particularly shown and described hereinabove. Rather the scope of the present invention is defined only by the claims which follow:

1. An imaging system comprising:
at least one focal plane array;
a plurality of optical pathways, each viewing different scenes; and
an optical switching assembly operative to supply to the at least one focal plane array outputs of the plurality of optical pathways in a time-shared manner.

2. An imaging system according to claim 1 wherein each focal plane array receives an output of only one of said plurality of optical pathways at a given time.

3. An imaging system according to claim 1 wherein each focal plane array receives multiple outputs at a given time, which outputs are refreshed at video rates, the resulting focal plane array output being operated upon by algorithms which sort out the various images.

4. An imaging system according to claim 1, wherein the plurality of optical pathways provide imaging over a 360 degree azimuth.

5. An imaging system according to claim 1 and wherein the focal plane array is stationary relative to an inertial platform during imaging .

6. An imaging system according to claim 1 and wherein the focal plane array operates at video rates and the optical switching assembly operates to supply a refreshed output from each of the plurality of optical pathways to the focal plane array at video rates.

7. An imaging system according to claim 1 and wherein the optical switching assembly employs mutually synchronized choppers associated with each of the optical pathways so as to ensure that at any given time, the focal plane array sees only one scene.

8. An imaging system according to claim 1 and wherein the optical switching assembly employs low inertia mirrors which are moved at high frequency so as to direct light from various scenes onto the focal plane array.
